(19) United States
(12) Patent Application Publication
(10) Pub. No.: US 2017/0362443 A1
(43) Pub. Date: Dec. 21, 2017

(54) AQUEOUS PRIMER

(71) Applicant: 3M INNOVATIVE PROPERTIES COMPANY, St. Paul, MN (US)

(72) Inventors: Lianzhou Chen, Woodbury, MN (US); Dmitriy Salnikov, Woodbury, MN (US)

(21) Appl. No.: 15/525,350

(22) PCT Filed: Dec. 22, 2015
(86) PCT No.: PCT/US2015/067439

§ 371 Date: May 9, 2017

Related U.S. Application Data
(60) Provisional application No. 62/095,141, filed on Dec. 22, 2014.

(51) Int. Cl. C09D 5/00; C09D 163/00; C08K 5/098; C08K 5/544

(52) U.S. Cl. CPC C09D 5/002; C09D 163/00; C08K 5/098; C08K 5/544

(57) ABSTRACT

A primer composition is presented comprising an aqueous dispersion of a) a thermosetting resin, b) an organosilane containing no hydrolyzable group, and c) a curing agent. In some embodiments, the primer composition additionally comprises d) a rare earth metal containing corrosion inhibitor. In some embodiments, the primer composition comprises no chromium. In some embodiments, the organosilane containing no hydrolyzable group is an aminosilanol. In some embodiments of the primer composition, the thermosetting resin is an epoxy resin and the curing agent is an epoxy curing agent. In some embodiments of the primer composition, the rare earth metal containing corrosion inhibitor is a cerium containing corrosion inhibitor.

### FIELD OF THE DISCLOSURE

This disclosure relates to aqueous primer compositions and methods of their use, in some embodiments as adhesive primers on metal surfaces.

### SUMMARY OF THE DISCLOSURE

Briefly, the present disclosure provides a primer composition comprising an aqueous dispersion of a) a thermosetting resin, b) an organosilane containing no hydrolyzable group, and c) a curing agent. In some embodiments, the primer composition additionally comprises d) a rare earth metal containing corrosion inhibitor. In some embodiments, the primer composition comprises no chromium. In some embodiments, the organosilane containing no hydrolyzable group is an aminosilanol. In some embodiments, the organosilane containing no hydrolyzable group is an aminosilanol according to formula I:

R²—NH—R¹—Si(OH)₃ [I].

wherein R¹ is a branched or linear alkylene group containing 1 to 20 carbon atoms, and wherein R² is selected from the group consisting of H and R²NH—R¹—, wherein when R² is R²—NH—R¹—, each R¹ and each R² are selected independently of any others and the molecular weight of no R² is more than 1500. In some embodiments, the organosilane containing no hydrolyzable group is an aminosilanol according to formula I:

R²—NH—R¹—Si(OH)₃ [I].

wherein R¹ is a branched or linear alkylene group containing 1 to 20 carbon atoms, and wherein R² is selected from the group consisting of H and H₂N—R¹—, wherein each R¹ is selected independently. In some embodiments, the organosilane containing no hydrolyzable group is an aminosilanol according to formula II:

H₂N—R¹—Si(OH)₃ [II].

wherein R¹ is a branched or linear alkylene group containing 1 to 20 carbon atoms. In some embodiments of the preceding formulas, R¹ is a linear alkylene group. In some embodiments of the preceding formulas, R¹ contains at least 2 carbon atoms. In some embodiments of the preceding formulas, no more than 10 carbon atoms; in some no more than 6 carbon atoms; in some no more than 4 carbon atoms; and in some no more than 3 carbon atoms. In some embodiments of the primer composition, the thermosetting resin is an epoxy resin. In some embodiments of the primer composition, the curing agent is an epoxy curing agent. In some embodiments, the curing agent is 2,2-bis-[4-(4-aminophenoxy)-phenyl]propane. In some embodiments of the primer composition, the rare earth metal containing corrosion inhibitor is a cerium containing corrosion inhibitor.

All scientific and technical terms used herein have meanings commonly used in the art unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

### DETAILED DESCRIPTION

The present disclosure provides aqueous primer compositions. In some embodiments the compositions are chromium-free. In some embodiments the compositions perform well as adhesive primers on metal surfaces. In some embodiments the compositions perform well as adhesive primers on sol-gel treated metal surfaces. In some embodiments the compositions perform well as adhesive primers on non-sol-gel treated metal surfaces. In some embodiments the compositions perform well as adhesive primers both on sol-gel treated metal surfaces and on non-sol-gel treated metal surfaces.

The following numbered embodiments are intended to illustrate the present disclosure but should not be construed to unduly limit this disclosure.
1. A primer composition comprising an aqueous dispersion of

a) a thermosetting resin,

b) an organosilane containing no hydrolyzable group,

c) a curing agent.
2. The primer composition according to embodiment 1 additionally comprising

d) a rare earth metal containing corrosion inhibitor.
3. The primer composition according to any of the preceding embodiments comprising no chromium.
5. The primer composition according to any of the preceding embodiments wherein the organosilane containing no hydrolyzable group is an aminosilanol.
6. The primer composition according to any of the preceding embodiments wherein the organosilane containing no hydrolyzable group is an aminosilanol according to formula I:

R²—NH—R¹—Si(OH)₃ [I].

wherein R¹ is a branched or linear alkylene group containing 1 to 20 carbon atoms, and wherein R² is selected from the group consisting of H and R²—NH—R¹—, wherein when R² is R²—NH—R¹—, each R¹ and each R² are selected independently of any others and the molecular weight of no R² is more than 1500.
7. The primer composition according to any of the preceding embodiments wherein the organosilane containing no hydrolyzable group is an aminosilanol according to formula I:

R²—NH—R¹—Si(OH)₃ [I].

wherein R¹ is a branched or linear alkylene group containing 1 to 20 carbon atoms, and wherein R² is selected from the group consisting of H and H₂N—R¹—, wherein each R¹ is selected independently.
8. The primer composition according to any of the preceding embodiments wherein the organosilane containing no hydrolyzable group is an aminosilanol according to formula II:

H₂N—R¹—Si(OH)₃ [II].

wherein R¹ is a branched or linear alkylene group containing 1 to 20 carbon atoms.
9. The primer composition according to any of embodiments 6-8 wherein R¹ is a linear alkylene group.
10. The primer composition according to any of embodiments 6-9 wherein R¹ contains at least 2 carbon atoms.
11. The primer composition according to any of embodiments 6-10 wherein R¹ contains no more than 10 carbon atoms.
12. The primer composition according to any of embodiments 6-10 wherein R¹ contains no more than 6 carbon atoms.
13. The primer composition according to any of embodiments 6-10 wherein R¹ contains no more than 4 carbon atoms.
14. The primer composition according to any of embodiments 6-10 wherein R¹ contains no more than 3 carbon atoms.
15. The primer composition according to any of the preceding embodiments wherein the thermosetting resin is an epoxy resin.
16. The primer composition according to any of the preceding embodiments wherein the curing agent is an epoxy curing agent.
17. The primer composition according to any of the preceding embodiments wherein the curing agent is 2,2-bis-[4-(4-aminophenoxy)-phenyl]propane.
18. The primer composition according to any of the preceding embodiments wherein the rare earth metal containing corrosion inhibitor is a cerium containing corrosion inhibitor.

Objects and advantages of this disclosure are further illustrated by the following examples, but the particular materials and amounts thereof recited in these examples, as well as other conditions and details, should not be construed to unduly limit this disclosure.

### EXAMPLES

The following abbreviations are used to describe the examples:

° C.: degrees Centigrade

° C./min: degrees Centigrade per minute

° F.: degrees Fahrenheit

° F./min: degrees Fahrenheit per minute

cm: centimeter

g/cm3 grams per cubic centimeter

ipfi: inch.pound-ft per inch

kgcw: kilograms per centimeter width

mg: milligram

mil: 10-3 inch

mm: millimeter

μm: micrometer

nm: nanometer

N.cm⁻¹: Newtons per centimeter

MPa: megaPascals

piw: pounds per inch width

Unless stated otherwise, all other reagents were obtained, or are available from fine chemical vendors such as Sigma-Aldrich Company, St. Louis, Mo., or may be synthesized by known methods. Unless otherwise reported, all ratios are by weight.

Abbreviations for reagents used in the examples are as follows:
AF-163: A structural adhesive film, available under the trade designation “SCOTCH-WELD STRUCTURAL ADHESIVE FILM AF-163-2K, 0.06 WEIGHT”, from 3M Company, St. Paul, Minn.
AF-191: A structural adhesive film, available under the trade designation “SCOTCH-WELD STRUCTURAL ADHESIVE FILM AF-191 K, 0.08 WEIGHT”, from 3M Company.
AF-3109: A structural adhesive film, available under the trade designation “SCOTCH-WELD STRUCTURAL ADHESIVE FILM AF-3109-2K, 0.085 WEIGHT”, from 3M Company.
AC-130-2: A high-performance sol gel surface preparation kit for adhesive bonding of aluminum alloys, obtained under the trade designation “SURFACE PRE-TREATMENT KIT AC-130-2” from 3M Company.
AEAPST: Aminoethylaaminopropylsilane triol.
APST: Aminopropylsilane triol.
ARCOSOLV: Propylene glycol (mono) butyl ether; obtained under the trade designation “ARCOSOLV PNB” from Lyondell Chemical Company, Houston, Tex.
BAPP: A 10% aqueous dispersion of 2,2-bis-[4-(4-aminophenoxy)-phenyl]propane, available from TCI America, Portland, Oreg. The BAPP was subsequently milled to a particle size of less than 15 μm and used as a 10% by weight aqueous dispersion.
CUREZOL: An imidazole curing agent obtained under the trade designation “CUREZOL 2MA-OK” from Air Products & Chemicals, Inc., Allentown, Pa.
ECN-1400: A stable, non-foaming high performance water-based epoxy cresol novolac resin dispersion, obtained under the trade designation “ARALDITE ECN 1400” from Huntsman Corporation, Woodlands, Tex.
EPZ-3546: A 53 wt. % solids dispersion of “EPONTM RESIN 1007” resin in water and methoxy propanol, obtained under the trade designation “EPI-REZ 3546-WH-53” from Momentive Specialty Chemicals, Columbus, Ohio.
EPZ-5108: A novolac-epoxy dispersion obtained under the trade designation “EPI-REZ DPW-5108” from Momentive Specialty Chemicals.
ETF: A 10% aqueous dispersion a non-chromated inhibitor, obtained under the trade designation “ECOTUFF” from United Technologies Corporation, Hartford, Conn. The ETF was subsequently milled to a particle size of less than 500 nm and used as a 30% by weight aqueous dispersion. ETF includes a molybdate oxyanion complex and a chelated cerium citrate complex.
FT-100: An epoxy toughening agent, obtained under the trade designation “FORTEGRA 100” from Dow Chemical Company, Midland, Mich.
FPL: An etch solution of sulfuric acid and sodium dichromate, obtained from Forest Products Laboratory, Madison, Wis.
IPA: Isopropyl alcohol.
M5: An untreated fumed silica, obtained under the trade designation “CAB-O-SIL M5” from Cabot Corporation, Tuscola, Ill.
MEK: Methyl ethyl ketone.
OAKITE 165: A caustic wash solution, obtained under the trade designation “OAKITE 165” from Chemetall, GmbH, Frankfurt am Main, Germany.
PZ-323: 75 wt. % aqueous emulsion of an epoxy phenol novolac resin, obtained under the trade designation “ARALDITE PZ-323” from Huntsman Corporation.
TDI: 4,4′ methylene bis (phenyl dimethyl urea.
U-52M: A micronized grade of an aromatic substituted urea, obtained under the trade designation “OMICURE U52M” from CVC Thermoset Specialties, Moorestown, N.J.

### Water Borne Primer Formulations

### Example 1

0.92 grams M5 was homogeneously dispersed in 14.45 grams PZ-323 by means of a high speed mixer operating at between 1,000-2,000 rpm for approximately 2-4 minutes at 25° C. With the mixer continuing to run at 300-500 rpm, 55.76 grams EPZ-3546 and 5.66 grams EPZ-5108 were blended into the dispersion, followed by 3.65 grams TDI. 9.11 grams IPA, 2.48 grams acetone, 0.74 grams ARCOSOLV, 113.4 grams of a 10% aqueous dispersion of BAPP, and 28.7 grams of a 30% aqueous dispersion of ETF inhibitor were slowly added, in 3-5 minute intervals. After 5 minutes, 2.46 grams APST organosilane was added and mixing continued for another 15 minutes. Deionized water was then added to adjust the resulting homogeneous aqueous sol gel primer dispersion to between 25-30 wt. %.

### Examples 2-7

The procedure generally described in Example 1 was repeated, according to the compositions listed in Table 1. The components are reported as weight ratios.

TABLE 1

| Component | Ex 1 | Ex. 2 | Ex. 3 | Ex. 4 | Ex. 5 | Ex. 6 | Ex. 7 |
|---|---|---|---|---|---|---|---|
| DI Water | 14.0 | 14.0 | 14.0 | 14.0 | 14.0 | 14.0 | 14.0 |
| M5 | 0.92 | 0.92 | 0.92 | 0.92 | 0.92 | 0.92 | 0.92 |
| PZ-323 | 14.45 | 14.45 | 14.45 | 14.45 | 14.45 | 14.45 | 14.45 |
| EPZ-3546 | 55.76 | 55.76 | 55.76 | 55.76 | 27.67 | 27.67 | 27.67 |
| ECN-1400 | 0 | 0 | 0 | 0 | 27.67 | 27.67 | 27.67 |
| ACROSOLV | 0.74 | 0.74 | 0.74 | 0.74 | 0.74 | 0.74 | 0.74 |
| EPZ-5108 | 5.66 | 5.66 | 5.66 | 5.66 | 5.66 | 5.66 | 5.66 |
| TDI | 3.65 | 3.65 | 3.65 | 3.65 | 3.07 | 3.07 | 3.07 |
| IPA | 9.11 | 9.11 | 9.11 | 9.11 | 9.11 | 9.11 | 9.11 |
| Acetone | 2.48 | 2.48 | 2.48 | 2.48 | 2.48 | 2.48 | 2.48 |
| FT-100 | 0 | 0 | 0 | 0 | 0 | 2.46 | 12.3 |
| BAPP | 113.4 | 113.4 | 56.2 | 135.0 | 154.0 | 154.0 | 154.0 |
| CUREZOL | 0 | 0 | 0.15 | 0 | 0 | 0 | 0 |
| ETF | 28.7 | 28.7 | 28.7 | 28.7 | 28.7 | 28.7 | 28.7 |
| APST | 2.46 | 0 | 0 | 0 | 2.46 | 2.46 | 2.46 |
| AEAPST | 0 | 2.46 | 2.46 | 2.46 | 0 | 0 | 0 |

### Substrate Preparation

Grade 2024T bare aluminum panels were obtained from Erickson Metals of Minnesota, Inc., Coon Rapids, Minn. Prior to bonding with structural adhesive, the panels were subjected to one of the following surface preparation processes:

### Panel Preparation 1

### FPL Etched/Anodized/Sol-Gel Primed Panels

The bare aluminum panel was soaked in OAKITE 165 caustic wash solution for 10 minutes at 85° C. The panel was then immersed in tap water for 10 minutes at 21° C., followed by a continuous spray rinsing with tap water for approximately 3 more minutes. The panel was then immersed in an FPL etch solution for 10 minutes at 66° C., after which the panel was spray rinsed with water for approximately 3 minutes at 21° C., allowed to drip dry for another 10 minutes, then dried in an oven for 30 minutes at 54° C. The etched panel was then anodized in a bath of 85% percent phosphoric acid at 72° F. (22.2° C.) for approximately 25 minutes at a voltage of 15 volts and a maximum current of 100 amps, rinsed with water for approximately 3 minutes at 21° C., allowed to drip dry for another 10 minutes, then dried in an oven for 10 minutes at 66° C. Within 24 hours of being anodized, the aluminum panel was sprayed with one of the sol-gel primer compositions described above, dried at 70° F. (21.1° C.) for 30 minutes, then cured in an oven set at 250° F. (121.1° C.) for 60 minutes. The resulting cured primer thickness was approximately 0.1-0.2 mils (2.5 to 5.1 μm).

### Panel Preparation 2

### Grit-Blasted/Surface Pre-Treated/Sol-Gel Primed

The bare aluminum panel was abraded by grit-blasting with 180-mesh (approximately 78 μm) alumina mineral in a closed cabinet until all of the oxide layer was removed, about 1-3 minutes. Residual grit was removed by means of compressed air, rinsing with solvent and allowing to dry for10 minutes at approximately 25° C. The aluminum panel was then pre-treated with AC-130-2 and dried at 75° F. (23.9° C.) for 60 minutes, after which it was sprayed with one of the sol-gel primer compositions described above, dried at 70° F. (21.1° C.) for 30 minutes, then cured in an oven set at 250° F. (121.1° C.) for 60 minutes. The resulting cured primer thickness was approximately 0.1-0.2 mils (2.5 to 5.1 μm).

### Panel Preparation 3

### FPL Etched/Surface Pre-Treated/Sol-Gel Primed

The bare aluminum panel was subjected to the FPL etch and AC-130-2 surface pre-treatment as described above, after which it was sprayed with one of the sol-gel primer compositions described above, dried at 70° F. (21.1° C.) for 30 minutes, then cured in an oven set at 250° F. (121.1° C.) for 60 minutes. The resulting cured primer thickness was approximately 0.1-0.2 mils (2.5 to 5.1 μm).

### Test Methods

Sol-gel primers of the present invention, along with Comparatives A and B, were evaluated according to one or more of the following tests. With respect to the bonding tests, the samples were subjected to one of the following cure cycles:

### Cure Cycle

The sample was vacuum bagged to a pressure of approximately 28 inches mercury (94.8 kPa) in an autoclave, model number “ECONOCLAVE 3×5”, from ASC Process Systems, Sylmar, Calif. Autoclave pressure was increased to 45 psi (310.3 kPa), during which the vacuum bag was vented to the atmosphere once the autoclave pressure surpassed 15 psi (103.4 kPa). Autoclave temperature was then increased at a rate of 4.5° F. (2.5° C.) per minute to one of the following set points:
250° F. (121.1° C.) for AF 163 and AF 3109
350° F. (176.7° C.) for AF 191
   After reaching the set point the sample was held for 60 minutes at this temperature, then cooled at a rate of 5° F. (2.8° C.) per minute to 72° F. (22.2° C.) before releasing the pressure.

### Overlap Shear (OSL) Test

One liner was removed from a 1-inch (25.4 mm) by ⅝-inch (15.9 mm) wide strip of structural adhesive film and the exposed adhesive manually pressed along the longer edge of a 63 mil (1.60 mm) thick, 4-inch by 7-inch (10.16 cm by 17.78 cm) aluminum test panel. After removing any trapped air bubbles by means of a rubber roller, the opposing liner was removed and another test panel was pressed onto the exposed adhesive, at an overlap of 0.5 inches (12.7 mm). The assembly was then taped together and autoclaved according to one of the cure cycles described above, after which the co-joined panels were cut into seven strips, each measuring 1-inch by 7.5 inches (2.54 by 19.05 cm). The strips were then evaluated for overlap shear strength according to ASTM D-1002, using a tensile strength tester, model “SINTECH 30” from MTS Corporation, Eden Prairie, Minn., at 70° F. (21.1° C.) and a grip separation rate of 0.05 inches/min. (1.27 mm/min.). Six overlap shear test panels were prepared and evaluated per each example. Results are listed in Tables 2-4 represent sol-gel primer evaluations with three different structural adhesive films and cure cycles.

TABLE 2
AF-163 STRUCTURAL ADHESIVE

| | Overlap Shear Strength (MPa) | | | | | |
|---|---|---|---|---|---|---|
| | Panel Preparation 1 | | | Panel Preparation 2 | | |
| | Test Temperature | | | | | |
| | 70° F. | 180° F. | 250° F. | 70° F. | 180° F. | 250° F. |
| Primer | (21.1° | (82.2° | (121.1° | (21.1° | (82.2° | (121.1° |
| Example | C.) | C.) | C.) | C.) | C.) | C.) |
| 1 | 43.6 | 30.3 | 19.0 | 39.9 | 28.8 | 17.4 |
| 4 | 43.6 | 30.6 | 12.3 | 43.6 | 27.4 | 9.5 |
| 5 | 42.8 | 29.0 | 18.4 | Not | Not | Not |
| | | | | Measured | Measured | Measured |
| 6 | 42.4 | 30.7 | 20.0 | 40.9 | 29.0 | 18.0 |
| 7 | 44.2 | 29.8 | 15.1 | Not | Not | Not |
| | | | | Measured | Measured | Measured |

TABLE 3
AF-191 STRUCTURAL ADHESIVE

| | Overlap Shear Strength (MPa) | | | | | |
|---|---|---|---|---|---|---|
| | Panel Preparation 1 | | | Panel Preparation 2 | | |
| | Test Temperature | | | | | |
| | 70° F. | 180° F. | 250° F. | 70° F. | 180° F. | 250° F. |
| Primer | (21.1° | (82.2° | (121.1° | (21.1° | (82.2° | (121.1° |
| Example | C.) | C.) | C.) | C.) | C.) | C.) |
| 1 | 42.2 | 25.0 | 18.2 | 35.0 | 11.7 | 9.9 |
| 5 | 38.5 | 23.1 | 15.3 | 37.9 | 20.1 | 14.6 |
| 6 | 41.1 | 24.0 | 16.7 | 37.6 | 19.1 | 14.0 |
| 7 | 38.7 | 23.0 | 17.8 | Not | Not | Not |
| | | | | Measured | Measured | Measured |

TABLE 4
AF-3109 STRUCTURAL ADHESIVE

| | Overlap Shear Strength (MPa) | | | | | |
|---|---|---|---|---|---|---|
| | Panel Preparation 1 | | | Panel Preparation 2 | | |
| | Test Temperature | | | | | |
| | 70° F. | 180° F. | 250° F. | 70° F. | 180° F. | 250° F. |
| Primer | (21.1° | (82.2° | (121.1° | (21.1° | (82.2° | (121.1° |
| Example | C.) | C.) | C.) | C.) | C.) | C.) |
| 1 | 44.7 | 36.9 | 26.3 | 36.5 | 31.3 | 24.2 |
| 5 | 42.1 | 35.2 | 21.5 | 34.1 | 28.8 | 22.9 |
| 6 | 43.4 | 32.8 | 23.7 | 34.6 | 31.0 | 22.3 |

### Floating Roller Peel (FRP) Test

Two test panels, one measuring 63 mils by 8-inches by 3-inches (1.60 mm by 20.32 cm by 7.62 cm), the other measuring 25 mils by 10-inches by 3-inches (0.635 mm by 25.4 cm by 7.62 cm), were bonded together with a structural adhesive and cured in the autoclave, as described in the Overlap Shear Test method. Test strips, 0.5 inches (12.7 mm) wide were cut from the bonded panel assembly and evaluated for floating roller peel strength of the thinner substrate, according to ASTM D-3167-76, using the tensile strength tester. Separation rate was 6 inches/minute (15.24 cm/min) at 70° F. (21.1° C.). Results were normalized for 1-inch (2.54 cm) wide test strips. Five test panels were prepared and evaluated per each example. Results are listed in Tables 5-7 represent sol-gel primer evaluations with three different structural adhesive films.

TABLE 5
AF-163 STRUCTURAL ADHESIVE

| | Floating Roller Peel Strength (N · cm⁻¹) | |
|---|---|---|
| Primer Example | Panel Preparation 1 | Panel Preparation 1 |
| 1 | 103.9 | 101.2 |
| 5 | 75.6 | Not Measured |
| 6 | 102.4 | 92.9 |
| 7 | 122.4 | 112.2 |

TABLE 6
AF-191 STRUCTURAL ADHESIVE

| | Floating Roller Peel Strength (N · cm⁻¹) | |
|---|---|---|
| Primer Example | Panel Preparation 1 | Panel Preparation 2 |
| 1 | 57.1 | 57.5 |
| 5 | 28.3 | 41.3 |
| 6 | 30.7 | 53.1 |
| 7 | 52.0 | 53.1 |

TABLE 7
AF-3109 STRUCTURAL ADHESIVE

| | Floating Roller Peel Strength (N · cm⁻¹) | |
|---|---|---|
| Primer Example | Panel Preparation 1 | Panel Preparation 2 |
| 1 | 83.1 | 70.1 |
| 5 | 20.1 | 46.1 |
| 6 | 70.5 | 92.9 |

### Climbing Drum Peel (CDP) Test

Two test panels, one measuring 40 mils by 16-inches by 8-inches (1.16 mm by 40.64 cm by 20.32 cm), the other measuring 20 mils by 16-inches by 8-inches (0.508 mm by 40.64 cm by 20.32 cm), were bonded together with a structural adhesive and cured in the autoclave as described in the Overlap Shear Test method Test strips, 1 inches (25.4 mm) wide were cut from the bonded panel assembly and evaluated for climbing drum peel strength of the thinner substrate, according to ASTM D-1781, using the tensile strength tester. Separation rate was 3 inches/minute (7.62 cm/min) at 70° F. (21.1° C.). Results listed in Table 8 were normalized for 1-inch (2.54 cm) wide test strips. Five test panels were prepared and evaluated per each example.

TABLE 8

| | Climbing Drum Peel Strength (cm · N · cm⁻¹) | |
|---|---|---|
| Primer Example | Panel Preparation 1 | Panel Preparation 2 |
| 1 | 100.5 | 113.7 |
| 2 | 111.2 | 79.4 |
| 3 | 111.5 | 115.9 |
| 4 | 118.6 | 117.5 |

### Hot/Wet Wedge Crack (HWWC) Test

Two test panels, measuring 125 mils by 6-inches by 6-inches (3.2 mm by 15.24 cm by 15.24 cm), were bonded together with a structural adhesive and cured in the autoclave as described in the Overlap Shear Test method. Test strips, 1 inches (25.4 mm) wide were cut from the bonded panel assembly and open the end of the test specimen that contains the separation film, and insert the wedge. The test coupon was evaluated for wedge crack test, according to ASTM 3762-03, after which they were placed in a controlled humidity chamber at 140° F. (60° C.) and 95% relative humidity. The crack growth and failure mode were subsequently evaluated after one week. Results are listed in Tables 9-11.

TABLE 9
AF-163 STRUCTURAL ADHESIVE

| Primer | Crack Width (mm)/Failure Mode | | |
|---|---|---|---|
| Example | Panel Preparation 1 | Panel Preparation 2 | Panel Preparation 3 |
| 1 | 2.57/(CF) | 3.40/(CF) | 3.40/(CF) |
| 2 | 3.06/(CF) | 3.03/(CF) | 3.03/(CF) |
| 3 | 3.32/(CF) | 2.65/(CF) | 2.65/(CF) |
| 4 | 2.59/(CF) | 2.50/(CF) | 2.50/(CF) |
| 1 | 3.75/(CF) | 4.20/(CF) | Not Measured |
| 5 | Not Measured | 2.93/(CF) | Not Measured |
| 6 | Not Measured | 3.28/(CF) | Not Measured |

*CF = Cohesive Failure;
PF = Primer Failure

TABLE 10
AF-191 STRUCTURAL ADHESIVE

| Primer | Crack Width (mm)/Failure Mode | |
|---|---|---|
| Example | Panel Preparation 1 | Panel Preparation 2 |
| 1 | 1.59/(CF) | 2.05/(CF) |
| 5 | Not Measured | 1.37/(CF) |
| 6 | Not Measured | 1.52/(CF) |

TABLE 11
AF-3109 STRUCTURAL ADHESIVE

| Primer | Crack Width (mm)/Failure Mode | |
|---|---|---|
| Example | Panel Preparation 1 | Panel Preparation 2 |
| 1 | 2.80/(CF) | 3.64/(CF) |
| 5 | Not Measured | 8.48/(CF) |
| 6 | Not Measured | 8.61/(CF) |

### Salt Corrosion Resistance Test

A primed, Augustm Grade 2024T bare aluminum, thickness 0.25-0.35 mil, was tested in Salt Spray Exposures Chamber in accordance with ASTM B-117. The results showed the sol-gel primers in the invention gave good corrosion resistance performance using different surface preparation (with sol-gel or without sol-gel surface treatment) after salt spray exposure, which is comparable to chromate based primers.

Various modifications and alterations of this disclosure will become apparent to those skilled in the art without departing from the scope and principles of this disclosure, and it should be understood that this disclosure is not to be unduly limited to the illustrative embodiments set forth hereinabove.

1. A primer composition comprising an aqueous dispersion of
a) a thermosetting resin,
b) an organosilane containing no hydrolyzable group,
c) a curing agent.

2. The primer composition according to claim 1 additionally comprising
d) a rare earth metal containing corrosion inhibitor.

3. The primer composition according to claim 1 comprising no chromium.

4. The primer composition according to claim 1 wherein the organosilane containing no hydrolyzable group is an aminosilanol.

5. The primer composition according to claim 1 wherein the organosilane containing no hydrolyzable group is an aminosilanol according to formula I:
R²—NH—R¹—Si(OH)₃ [I].
wherein R¹ is a branched or linear alkylene group containing 1 to 20 carbon atoms, and wherein R² is selected from the group consisting of H and R²—NH—R¹—, wherein when R² is R²—NH—R¹—, each R¹ and each R² are selected independently of any others and the molecular weight of no R² is more than 1500.

6. The primer composition according to claim 1 wherein the organosilane containing no hydrolyzable group is an aminosilanol according to formula I:
R²—NH—R¹—Si(OH)₃ [I].
wherein R¹ is a branched or linear alkylene group containing 1 to 20 carbon atoms, and wherein R² is selected from the group consisting of H and H₂N—R¹—, wherein each R¹ is selected independently.

7. The primer composition according to claim 1 wherein the organosilane containing no hydrolyzable group is an aminosilanol according to formula II:
H₂N—R¹—Si(OH)₃ [II].
wherein R¹ is a branched or linear alkylene group containing 1 to 20 carbon atoms.

8. The primer composition according to claim 5 wherein R¹ is a linear alkylene group.

9. The primer composition according to claim 5 wherein R¹ contains at least 2 carbon atoms.

10. The primer composition according to claim 5 wherein R¹ contains no more than 10 carbon atoms.

11. The primer composition according to claim 5 wherein R¹ contains no more than 4 carbon atoms.

12. The primer composition according to claim 5 wherein R¹ contains no more than 3 carbon atoms.

13. The primer composition according to claim 1 wherein the thermosetting resin is an epoxy resin.

14. The primer composition according to claim 1 wherein the curing agent is an epoxy curing agent.

15. The primer composition according to claim 1 wherein the rare earth metal containing corrosion inhibitor is a cerium containing corrosion inhibitor.
